(19) United States
(12) Patent Application Publication
(10) Pub. No.: US 2014/0370984 A1
(43) Pub. Date: Dec. 18, 2014

(54) GAME PROVIDING SYSTEM, NON-TRANSITORY COMPUTER-READABLE STORAGE MEDIUM STORING GAME PROVIDING PROGRAM, AND GAME PROVIDING METHOD

(71) Applicant: DeNA Co., Ltd., Tokyo (JP)

(72) Inventor: Yasunori BEPPU, Tokyo (JP)

(73) Assignee: DeNA Co., Ltd., Tokyo (JP)

(21) Appl. No.: 14/258,537

(22) Filed: Apr. 22, 2014

(30) Foreign Application Priority Data
Jun. 14, 2013 (JP) 2013-125621

(51) Int. Cl. A63F 13/00

(52) U.S. Cl. CPC A63F 13/00
USPC 463/31

(57) ABSTRACT

A game providing system according to an embodiment of the present invention includes one or a plurality of processors capable of executing a non-transitory computer-readable storage medium storing a game program. In an embodiment, when it has been determined that a predetermined number or more of objects of one type have been continuously selected from among a plurality of objects arranged in a game field, the non-transitory computer-readable storage medium storing a game program causes a display area in which an object of a different type from the objects of one type is arranged among the display areas of the objects in the game field to be a first cancellation operation area.

### BACKGROUND OF THE INVENTION

1. Field of the Invention

The present invention relates to a game providing system, a non-transitory computer-readable storage medium storing a game providing program, and a method of providing a game. To be specific, an embodiment of the present invention relates to a game providing system, a non-transitory computer-readable storage medium storing a game providing program, and a method of providing a game, for providing a puzzle game in which, when one or a plurality of objects arranged in a game field is selected by a player, points or items according to the selected objects are granted to the player.

2. Description of Related Art

A puzzle game, in which, when an object arranged in a game field is selected by a player, points or items according to the selection are granted to the player, is known. For example, as a typical puzzle game of this sort, there are “Puzzle Craft” provided by Chillingo Ltd. (see Non-Patent Literature 1), and “Dungeon Raid” provided by FireFlame Games. In “Puzzle Craft”, objects such as grass, trees, vegetables, and the like are respectively arranged in a total of 36 display areas in a six-row and six-column grid pattern, and the player continuously selects objects of the same type in a unicursal manner, thereby to acquire points or game items according to the number or the type of the selected objects.

In the puzzle game of this sort, as the number of the objects arranged in the game field is increased, a method of selecting the objects by the player varies, and a demand to select the objects by another method even after a selection operation has been started is caused. Therefore, a typical puzzle game is configured such that, even after the selection operation of the objects has been started, a predetermined cancellation area arranged on a game screen is selected, whereby the selection operation before confirmation can be canceled.

Non-Patent Literature 1: “Puzzle Craft”, [Online], Chillingo Ltd., [Searched on May 29, 2013], the Internet <https://itunes.apple.com/us/app/puzzle-craft/id489178757?mt=8>

Non-Patent Literature 2: “Dungeon Raid”, [Online], FireFlame Games, [Searched on May 29, 2013], the Internet <https://itunes.apple.com/jp/app/dungeon-raid/id403090531?mt=8>

### SUMMARY OF THE INVENTION

However, in the typical puzzle game, the cancellation operation area to cancel the selection operation is provided outside the game field in which the objects are arranged. Therefore, an object subjected to the selection operation is apart from the cancellation operation area, and this causes an operation error (for example, cancellation of the selection was intended but the selection is confirmed by mistake, and the like).

Therefore, an objective of the present invention is to provide a puzzle game in which a selection operation to an object can be cancelled in a game field in which the object is arranged. Other objectives of the present invention will become clear by reference to the present specification as a whole.

A game providing system according to an embodiment of the present invention includes one or a plurality of processors capable of executing a non-transitory computer-readable storage medium storing a game program. Further, a non-transitory computer-readable storage medium storing a game program according to an embodiment of the present invention is configured to cause a computer to function as a game providing device. In an embodiment, the non-transitory computer-readable storage medium storing a game program includes: an object arrangement module configured to arrange one object from among a plurality of types of objects to each of a plurality of display areas included in a game field; a determination module configured to determine whether a predetermined number or more of objects of one type have been continuously selected from among a plurality of objects arranged in the plurality of display areas by a selection operation of a player; a cancellation operation area generation module configured to cause a display area in which an object of a different type from the objects of one type is arranged among the objects arranged in the plurality of display areas to be a first cancellation operation area when it has been determined by the determination module that a predetermined number or more of objects of one type have been continuously selected; a selection cancellation module configured to cancel the selection of the objects of one type when the first cancellation operation area has been selected; a selection confirmation module configured to confirm the selection of the objects of one type when a predetermined confirmation condition has been satisfied before the first cancellation operation area is selected; and an acquisition point determination module configured to determine an acquisition point to be acquired by the player when the selection of the objects of one type has been confirmed by the selection confirmation module.

A method of providing a game according to an embodiment of the present invention is executed by a computer, and the method includes: an object arrangement step of arranging one object from among a plurality of types of objects to each of a plurality of display areas included in a game field; a determination step of determining whether a predetermined number or more of objects of one type have been continuously selected from among a plurality of objects arranged in the plurality of display areas by a selection operation of a player; a cancellation operation area generation step of causing a display area in which an object of a different type from the objects of one type is arranged among the objects arranged in the plurality of display areas to be a first cancellation operation area when it has been determined in the determination step that a predetermined number or more of objects of one type have been continuously selected; a selection cancellation step of cancelling the selection of the objects of one type when the first cancellation operation area has been selected; a selection confirmation step of confirming the selection of the objects of one type when a predetermined confirmation condition has been satisfied before the first cancellation operation area is selected; and an acquisition point determination step of determining an acquisition point to be acquired by the player when the selection of the objects of one type has been confirmed in the selection confirmation step.

According to various embodiments of the present invention, a puzzle game is provided, in which a selection operation to an object can be cancelled in a game field where the object is arranged.

### BRIEF DESCRIPTION OF THE DRAWINGS

FIG. 1 is a block diagram schematically illustrating a network configuration of a system in which a non-transitory computer-readable storage medium storing a game program according to an embodiment of the present invention is executed;

FIG. 2 is a block diagram illustrating a function of the non-transitory computer-readable storage medium storing a game program according to an embodiment of the present invention;

FIG. 3 is an explanatory diagram illustrating an example of a game screen displayed in a system according to an embodiment of the present invention;

FIG. 4 is an explanatory diagram illustrating an example of a game screen displayed in a system according to an embodiment of the present invention;

FIG. 5 is an explanatory diagram illustrating an example of a game screen including a cancellation operation area displayed in an embodiment of the present invention;

FIG. 6 is an explanatory diagram illustrating another example of the game screen including a cancellation operation area displayed in an embodiment of the present invention;

FIG. 7 is an explanatory diagram illustrating still another example of the game screen including a cancellation operation area displayed in an embodiment of the present invention;

FIG. 8 is an explanatory diagram illustrating an example of a game screen displayed in a system of an embodiment of the present invention; and

FIG. 9 is a flowchart illustrating a flow of processing from start to end of a game according to an embodiment of the present invention.

### DETAILED DESCRIPTION OF THE INVENTION

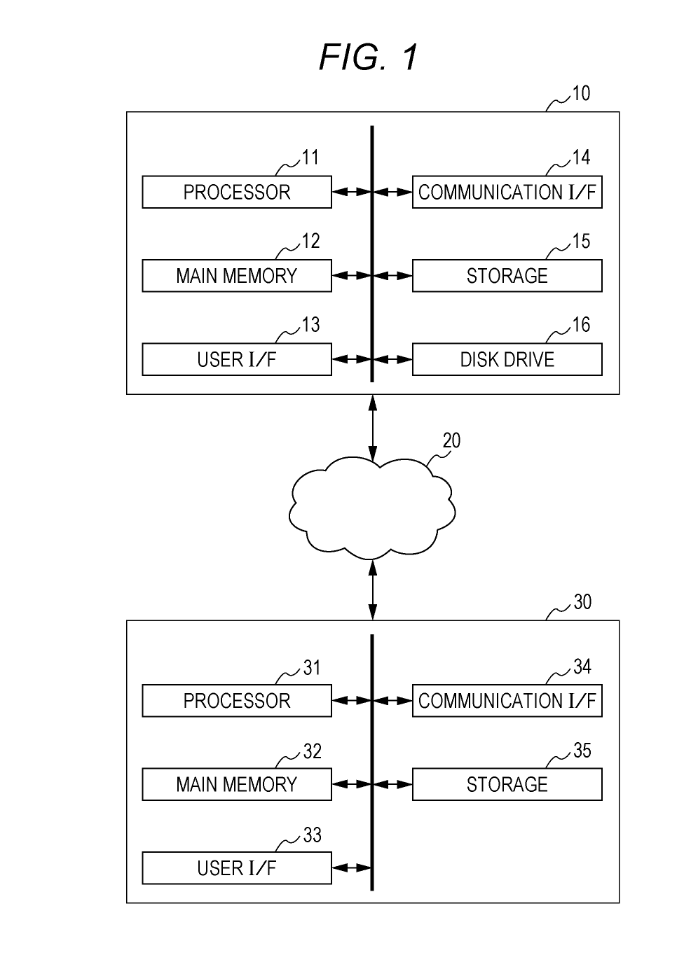

FIG. 1 is a block diagram schematically illustrating a network configuration of a game providing system in which a non-transitory computer-readable storage medium storing a game program according to an embodiment of the present invention is executed. The game providing system according to an embodiment of the present invention includes at least one of a server 10 and a terminal device 30, as illustrated in FIG. 1. The server 10 is communicatively connected with the terminal device (client) 30 through a communication network 20 such as the Internet, and provides the player who operates the terminal device 30 with a game. While one terminal device 30 is illustrated in FIG. 1, a plurality of terminal devices 30 can be communicatively connected with the server 10.

The server 10 includes, as illustrated in the drawing, a processor 11, a main memory 12, a player I/F 13, a communication I/F 14, a storage 15, and a disk drive 16, and these configuration elements are electrically connected with each other through a bus 17. The processor 11 loads an operating system and various programs that control a progress of a game from the storage 15 to the main memory 12, and executes instructions included in the loaded programs. The main memory 12 is used to store the programs executed by the processor 11, and is configured from a DRAM, for example.

The player I/F 13 includes, for example, an information input device such as a keyboard and a mouse that receive an input of an operator, and an information output device such as a liquid crystal display that outputs a calculation result of the processor 11. The communication I/F 14 is implemented as hardware, firmware, communication software such as a TCP/IP driver or a PPP driver, or a combination thereof, and is communicatively connected with the terminal device 30 through the communication network 20.

The storage 15 is configured from a magnetic disk drive, for example, and various programs such as a control program for controlling the progress of a game and the like are stored therein. Further, various data used in the game is also stored in the storage 15. Various data that can be stored in the storage 15 may be stored in a database server physically separated from the server 10 that is communicatively connected with the terminal device 30. The disk drive 16 reads data stored in various storage media such as a CD-ROM, a DVD-ROM, and a DVD-R, or writes data in these storage media. For example, game applications and data such as game data stored in the storage media are read out by the disk drive 16 and installed in the storage 15.

The server 10 in one embodiment is a web server that manages a web site made of a plurality of web pages in a hierarchical structure, and can provide the terminal device 30 with a game service. The terminal device 30 acquires HTML data for displaying a web page from the server 10, analyzes the acquired HTML data, and can present the web page to the player of the terminal device 30 (the player of the game). The game provided through such a web page may be called browser game. HTML data for displaying the web page is also stored in the storage 15. The HTML data is made of HTML documents described in a markup language such as HTML, and various images are associated with the HTML documents. Further, programs described in a script language such as ActionScript or JavaScript (registered trademark) can be embedded in the HTML data.

A game application executed on an execution environment other than browser software in the terminal device 30 can also be stored in the storage 15. The game application can include a game program for executing a game and various data such as image data referred at execution of the game program. The game program is created in an object-oriented programming language such as Objective-C or Java (registered trademark). The created game program is stored in the storage 15 as application software together with various data. The application software stored in the storage 15 is distributed to the terminal device 30 in response to a distribution request. The application software distributed from the server 10 is received by the terminal device 30 through a communication I/F 34 according to control of a processor 31, and the received game program is transmitted to a storage 35 and stored therein. The application software is started in response to an operation of the terminal device 30 by the player, and is executed on a platform such as NgCore (trademark) or Android (trademark) implemented in the terminal device 30. The server 10 provides the game application executed in the terminal device 30 with various data necessary for the progress of a game. Further, the server 10 can manage the progress of a game for each player by storing the various data transmitted from the terminal device 30 for each player.

As described above, the server 10 manages the web site that provides a game service, and can make a game progress by distributing a web page that configures the web site in response to a request from the terminal device 30. Further, the server 10 can make the game progress based on the communication with a game application executed in the terminal device 30, alternatively from or in addition to the browser game. The server 10 can store data necessary for the progress of a game for each piece of identification information that identifies each player whichever form is used to provide a game. While detailed description is omitted, the server 10 can include a function to perform authentication processing of the player at the start of the game and charge processing occurring according to the progress of the game. The game provided by the server 10 includes any game such as an action game, a roll-playing game, a baseball game, a card game, and a puzzle game. The type of the games realized by the web site of the server 10 or the game application is not limited to the explicit examples in the present specification.

The terminal device 30 is an arbitrary information processing device in which the web page of the game web site acquired from the server 10 is displayed on the web browser, and an application execution environment for executing the game application is implemented. Examples of the terminal device 30 include, but are not limited to, a mobile phone, a smart phone, a tablet terminal, a personal computer, an electronic book reader, and a game console.

The terminal device 30 includes, as illustrated in the drawing, the processor 31, a main memory 32, a player I/F 33, the communication I/F 34, and the storage 35, and these configuration elements are electrically connected with each other through a bus 36.

The processor 31 loads various programs such as an operating system from the storage 35 to the main memory 32, and executes instructions included in the loaded programs. The main memory 32 is used to store the programs executed by the processor 31, and is configured from a DRAM, for example.

The player I/F 33 is an information input device that receives an input of the player and is an information output device that outputs a calculation result of the processor 31, and includes a display device such as a liquid crystal display including a touch panel.

The communication I/F 34 is implemented as hardware, firmware, communication software such as a TCP/IP driver or a PPP driver, or a combination thereof, and is communicatively connected with the server 10 through the communication network 20.

The storage 35 is configured from a magnetic disk drive, a flash memory, or the like, for example, and stores various programs such as the operation system. Further, when having received the game application from the server 10 through the communication I/F 34, the storage 35 stores the received game application.

The terminal device 30 having such architecture is an example of a game providing device that provides a game. The terminal device 30 includes browser software for interpreting a file (HTML data) in an HTML format and displaying the data on the screen, for example. With the browser software function, the terminal device 30 can interpret the HTML data acquired from the server 10 and display a web page corresponding to the received HTML data. Further, the terminal device 30 includes plug-in software incorporated in the browser software (for example, Flash Player provided by Adobe Systems Inc.). The terminal device 30 can acquire a file in an SWF format embedded in the HTML data from the server 10, and execute the file in the SWF format using the browser software and the plug-in software. Further, in the terminal device 30, the game application is started in response to an operation of the player, and is executed on a platform implemented in the terminal device 30.

When a game is executed in the terminal device 30, animations and operation icons instructed by the program are displayed on the screen of the terminal device 30, for example. The player can input an instruction for making the game progress using an input interface of the terminal device 30. The instruction input from the player is transferred to the server 10 through the browser and a platform function such as NgCore (trademark) of the terminal device 30.

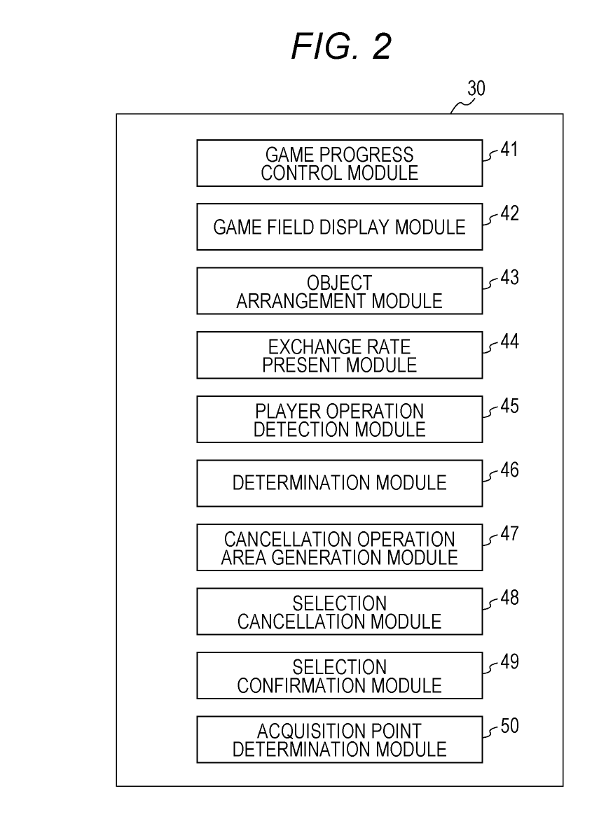

Next, functions of the terminal device 30 will be described with reference to FIG. 2. The functions of the terminal device 30 are realized by various modules executed by the processor 31. As illustrated in FIG. 2, the modules executed by the processor 31 include a game progress control module 41 that controls the progress of a game, a game field display module 42 that displays a game field in the display, and an object arrangement module 43 that displays an object in each of a plurality of display areas included in the game field. As described below, the objects in an embodiment of the present invention include a plurality of types of objects. The plurality of types of objects includes at least a reference object and a variation object. The reference object and a reference point, and the variation object and a variation point will be described below.

The modules executed by the processor 31 further include an exchange rate present module 44 that presents, to the player, an exchange rate at which the reference point associated with the reference object is exchanged for the variation point associated with the variation object, a player operation detection module 45 that detects a selection operation of an element (for example, an object or a cancellation operation area) within the game screen by the player, a determination module 46 that determines whether a predetermined number or more of objects of one type have been continuously selected by the player, a cancellation operation area generation module 47 that causes, when a predetermined number or more of objects of one type have been continuously selected by the player, a display area in which an object of a different type from the objects of one type is arranged to be a first cancellation operation area, a selection cancellation module 48 that cancels the selection of the objects of one type when the first cancellation operation area has been selected, a selection confirmation module 49 that confirms the selection of the objects of one type when a predetermined confirmation condition has been satisfied before the first cancellation operation area is selected, and an acquisition point determination module 50 that determines an acquisition point to be acquired by the player when the selection of the objects of one type has been confirmed.

The modules illustrated in FIG. 2 are merely examples. The terminal device 30 may execute a module other than the illustrated modules, or may not execute a part of the illustrated modules. Further, a part or all of the modules illustrated in FIG. 2 may be executed by a processor provided outside the terminal device 30 (for example, the processor 11 of the server 10) or a processor provided in another terminal device. When a part or all of the modules illustrated in FIG. 2 are executed by a processor other than the terminal device 30, the terminal device 30 receives a processing result by the external processor, and displays a game screen based on the processing result, thereby to provide a game.

In an embodiment, a part or all of the programs that realize the modules of FIG. 2 may be provided from the server 10 to the terminal device 30 in a format embedded in the HTML document. Further, in another embodiment, a part or all of the modules of FIG. 2 may be provided to the terminal device 30 in a format of a game application.

In an embodiment of the present invention, these modules are executed by one or a plurality of processors such as the processor 31, so that a puzzle game is provided. The puzzle game is configured such that objects are respectively arranged in a plurality of display areas included in the game field, and the player acquires points according to the type or the number of objects selected by the player, for example. The objects include at least two types of objects: the reference object and the variation object, as described above. The reference point is associated with the reference object, and the variation point is associated with the variation object. In the puzzle game according to an embodiment of the present invention, an exchange rate between the variation point and the reference point is determined, and the variation point is determined based on the reference point and the exchange rate.

The puzzle game in an embodiment of the present invention is configured to end when predetermined turns have passed, and to compete for a total of the acquisition points at the end of the game. For example, in each turn, a selection operation to select objects by the player is detected, and an acquisition point of the player is calculated based on the selection operation. When the acquisition point is calculated in each turn, the game moves onto a next turn. The above process is repeated by predetermined turns (for example, 10 turns), and the total points acquired at the time when the predetermined turns have passed (accumulated acquisition points of the turns) are completed.

In one embodiment, objects displayed in a touch screen-type display are selected by the player in a unicursal manner. The puzzle game in one embodiment is configured such that the player acquires points when objects of the same type are continuously selected by the player in a unicursal manner, for example. The puzzle game in one embodiment is configured such that, even if the player has started the selection operation of the objects, the selection operation can be cancelled if the selection operation is before the confirmation. After the selection operation is cancelled, the turn can be started from the beginning, for example. The cancellation operation of the selection operation is executed by the player selecting the cancellation operation area included in the game screen, for example.

In an embodiment, the acquisition points after the elapse of predetermined turns are accumulated by the server 10 for each player, and an accumulation result is presented as a ranking. Accordingly, the player is motivated to maximize the acquisition point after the elapse of the predetermined turns. The puzzle game in an embodiment of the present invention completes for the total acquisition point in a plurality of turns. However, the puzzle game may not be necessarily configured to accumulate the ranking and to show superiority and inferiority of other players. That is, the player is motivated to maximize the acquisition point by being presented the total acquisition point in the predetermined turns even if the player does not know the acquisition points of other players.

Hereinafter, functions of the modules of FIG. 2 will be further described. The game progress control module 41 transmits/receives various data necessary for the progress of a game provided by the server 10 to/from the server 10 as necessary, and controls the progress of the game. For example, the game progress control module 41 sequentially acquires various types of web pages necessary for the progress of the game from the server 10, and displays the web pages in a display 33a of the terminal device 30. As described above, the web pages stored in the server 10 are sequentially displayed in a display of the terminal device 30 according to an operation of the player. Therefore, the player can make the game progress based on own operations with the function of the game progress control module 41.

In the terminal device 30, when the program provided as the game application is executed, the game progress control module 41 is executed on a predetermined application platform. The game progress control module 41 can transmit/receive information related to the progress of the game to/from the server 10. For example, when a predetermined stage has been cleared in the game being in execution, for example, the game progress control module 41 can transmit the acquisition point at this stage to the server 10, acquire various data related to a stage next to the cleared stage from the server 10, and loads the acquired data and make the game progress.

The game progress control module 41 can appropriately transmit information related to the progress of the game such as information indicating various types of parameter values used in a game (information related to the number of acquired game points, an acquired item, and the like) and information indicating a status (information identifying a cleared stage, and the like) to the server 10 using the functions of the browser software and the game application. The server 10 can control the progress of the game for each player by storing the information related to the progress of the game received from a plurality of terminal devices 30 for each player. Accordingly, when the player logs in the server 10 using an own ID, the player can resume the game from a stage according to the progress of the player based on the information related to the progress of the game held by the server 10 corresponding to the player.

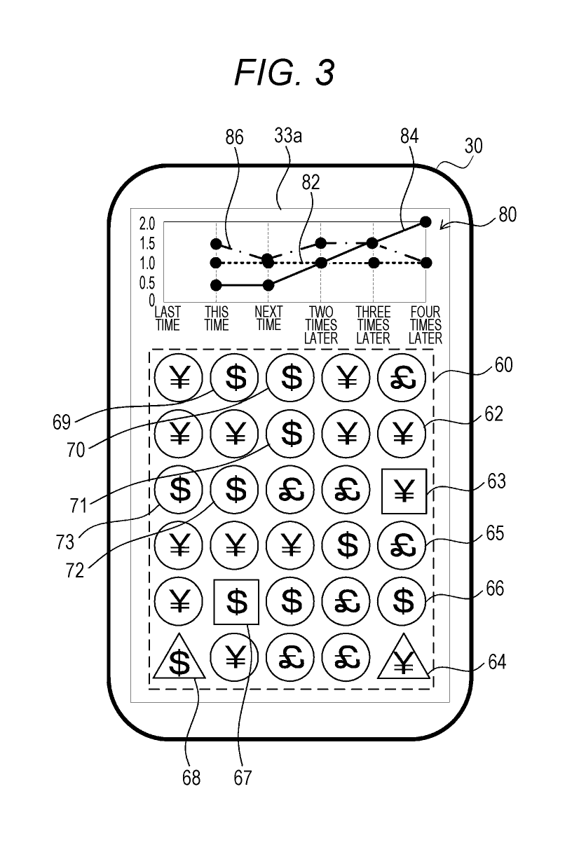

The game field display module 42 is configured to display a game field used in the puzzle game in the display 33a of the terminal device 30 when the puzzle game provided in the terminal device 30 is executed. FIG. 3 illustrates an example of a display screen displayed in the display 33a of the terminal device 30. In an embodiment, the display 33a may be a touch panel-type display. The display screen of FIG. 3 illustrates an example of a game screen displayed in the terminal device 30 in a first turn at execution of the puzzle game in an embodiment. The display screen is displayed in the terminal device 30 when the player who operates the terminal device 30 requests, to the server 10, display of a web page for playing the puzzle game, or the application of the puzzle game is executed in the terminal device 30.

A game field 60 is arranged in a lower side area of the display screen exemplarily illustrated in FIG. 3, and an exchange rate field 80 described below is arranged in an upper side area. In the example of FIG. 3, a total of thirty circular display areas are included in the game field 60 in a five-row and six-column grid pattern, and the objects are respectively arranged in the display areas.

The object arrangement module 43 is configured to respectively arrange the objects in the plurality of display areas included in the game field 60. In the present specification, the object means a target to be selected or a target to be operated by the player, which is displayed on the game screen. In the embodiment of FIG. 3, each of graphics of a circle, a rectangle, or a triangle that surrounds “¥”, “$”, and “£” represents an example of the object. To be specific, in the game field 60 of FIG. 3, three types of objects including: objects of “¥” surrounded by a circle, a square, or a triangle (hereinafter, referred to as “yen object”); objects of “$” surrounded by a circle, a square, or a triangle (hereinafter, referred to as “dollar object”; and an object of “£” surrounded by a circle (hereinafter, referred to as “pound object”) are arranged. While not illustrated in FIG. 3, pound objects surrounded by a square and a triangle may be arranged in the display area of the game field 60.

As described above, the thirty display areas are included in the game field of FIG. 3 and any of the three types of the objects is arranged in each of the thirty display areas by control of the object arrangement module 43. Note that, since a large number of objects are displayed in FIG. 3, illustration of reference signs of some of the objects is omitted.

As described above, the objects in an embodiment of the present invention include at least the reference object and the variation object. In the embodiment illustrated in FIG. 3, a yen object 62 is the reference object associated with the reference point, and a dollar object 66 and a pound object 65 are the variation objects associated with the variation points. Objects other than the yen object 62 can be the reference object. For example, the dollar object 66 or the pound object 65 can be the reference objects, and the yen object 62 can be the variation object. In FIG. 3, the three types of objects are illustrated. However, the objects in the present invention may be classified into two types (for example, the yen object and the dollar object) or may be classified into four types.

As described below, in the present embodiment, the player of the puzzle game can acquire points according to the type or the number of the selected objects by selecting the objects displayed on the game screen. Each object is associated with the reference point or the variation point according to the type of the object, and when objects are selected by the player, the acquisition point is calculated based on the points associated with the selected objects or the number of selected objects.

In a part of the embodiment of the present invention, objects of the same type are classified into different ranks. Even if objects are the same type, objects in different ranks are associated with different points. For example, in the game screen of FIG. 3, symbols representing the currency of “¥”, “$”, and “£” show the types of the objects, and the shapes of the graphics representing the currency (the circle, the rectangle, and the triangle) distinguish the ranks of the objects. For example, the object surrounded by the circle is a lowest rank, the object surrounded by the rectangle is a medium rank, and the object surrounded by the triangle is a highest rank. In the embodiment of FIG. 3, the yen object 62 surrounded by the graphic of the circle is classified into the lowest rank, and is associated with a lowest reference point (for example, “100 points”). Further, a yen object 63 surrounded by the square is classified into the medium rank, and is associated with a medium reference point (for example, “1000 points”). Further, a yen object 64 surrounded by the triangle is classified into a highest rank, and is associated with a highest reference point (for example, “10000” points). The dollar object and the pound object can be similarly classified into the three ranks. A method of classifying the ranks applicable to the present invention is not limited to the above-described method. For example, objects of one type may be classified into four or more ranks, and different points may be associated with the respective ranks.

The exchange rate present module 44 presents, to the player, an exchange rate between the reference point associated with the yen object that is the reference object and the variation point associated with the dollar object that is one type of the variation objects (may be referred to as “yen-dollar exchange rate”). Further, in an embodiment, the exchange rate present module 44 can present, to the player, an exchange rate between the reference point and the variation point associated with the pound object that is one type of the variation objects (may be referred to as “yen-pound exchange rate”).

Graphs and numerical values indicating the exchange rates are displayed in the display 33a as a part of the game screen, for example. The exchange rate present module 44 can present, to the player, not only the exchange rate of the current turn, but also the exchange rates of several turns ahead. For example, the exchange rates in the embodiment of FIG. 3 are displayed in a graph format in the exchange rate field 80 in the display screen. The horizontal axis of the graph represents a turn of the game, and the exchange rates between the reference point and the variation points (the yen-dollar exchange rate and the yen-pound exchange rate) of each turn from a previous turn (displayed as “last time”) of the current turn (displayed as “this time”) to a turn of four times later are illustrated. In the example of FIG. 3, the yen-dollar exchange rate and the yen-pound exchange rate can take values in a range of “0” to “2.0” at “0.5” intervals.

In the present invention, the range that the exchange rate can take is not limited to the above-described range of 0 to 2.0, and any range can be applied. Further, an adjustment width thereof is not limited to the “0.5” intervals, and can be set to any width. Further, a specific method of presenting the exchange rate to the player in the present invention is not limited to be the above-described method. For example, the exchange rate may be displayed in the display 33a as a different screen from the game screen, and may be displayed in any display device other than the display 33a. Further, the exchange rate may be presented to the player using reading of a voice, or a sense other than the sense of sight such as tactile sense communication.

In an embodiment of the present invention, the variation point associated with the dollar object is calculated by multiplying the reference point associated with the yen object by the yen-dollar exchange rate. The exchange rate may be calculated based on a predetermined algorithm in each turn (for example, may be randomly calculated using a pseudorandom number). Alternatively, the exchange rate in each turn until the end of the game may be determined in advance before the start of the game. When the exchange rate is calculated in each turn, the variation point is calculated based on a calculated exchange rate and the reference point. The variation point of the dollar object calculated in this way is stored in association with the dollar object in a referable form at the calculation of the acquisition point described below. Similar processing is performed for the variation point of the pound object.

As described above, in an embodiment, objects of the same type are classified into different ranks. The variation point of the variation object is calculated by multiplying the reference point associated with the yen object in the same rank as the variation object by the exchange rate. For example, the variation point of the dollar object classified into the lowest rank is calculated by multiplying the reference point associated with the yen object similarly classified into the lowest rank, among the reference objects (yen objects), by the exchange rate between the yen object and the dollar object. As an example, when the reference point in the lowest rank is 100 points, and the exchange rate between the reference object and the dollar object is “1.5”, the variation point associated with the dollar object is “150 points” that are obtained by multiplying “100” by “1.5”. Similarly, when the reference point in the highest rank is 10000 points, and the exchange rate between the reference object and the dollar object is “1.5”, the variation point associated with the dollar object in the highest rank is “15000 points” that are obtained by multiplying “10000” by “1.5”. The variation points of the variation objects classified into other ranks are similarly determined. The variation point associated with the pound object 65 is similarly determined.

In the embodiment illustrated in FIG. 3, the player of the puzzle game views the display screen illustrated in FIG. 3, and can select the objects displayed in the game field 60 according to a predetermined rule. When the display 33a is a touch panel, the player can select the object by dragging or tapping the position where the object he/she wishes to select is displayed on the surface of the display 33a. Similarly to a typical puzzle game, the player can continuously select objects of the same type by a drag operation in a unicursal manner, for example. Such a selection operation of the player is detected in the player operation detection module 45 in an embodiment of the present invention.

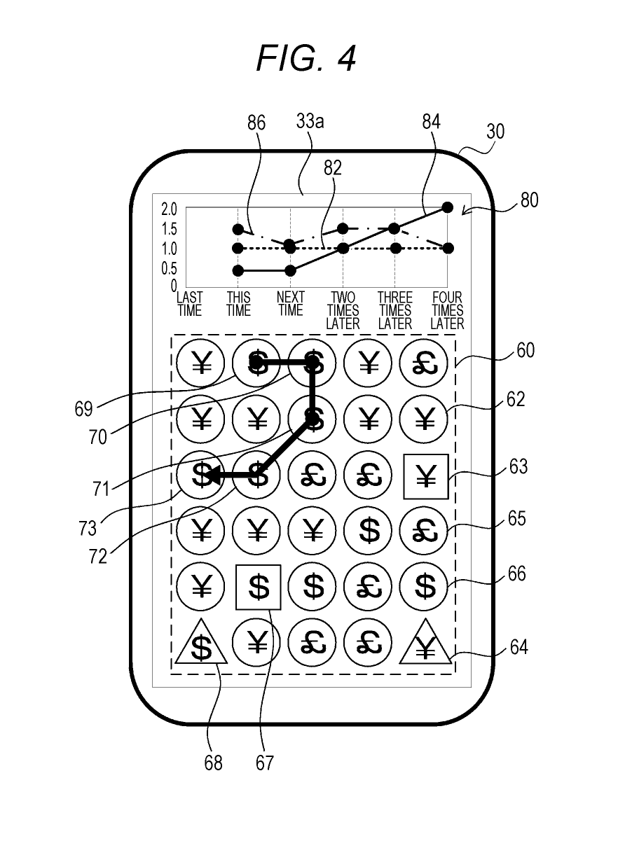

Selection of an object will be further described with reference to FIG. 3. As illustrated in FIG. 3, in an object field 60, a dollar object 69 and a dollar object 70, a dollar object 70 and a dollar object 71, a dollar object 71 and a dollar object 72, and a dollar object 72 and a dollar object 73 are arranged adjacent to each other. At this time, the player can continuously select the five dollar objects in order of the dollar objects 69, 70, 71, 72, and 73 by a drag operation, as illustrated by the virtually thick arrow in FIG. 4. In this case, the player operation detection module 45 can detect the dollar objects 69, 70, 71, 72, and 73 have been continuously selected. As for the yen object and the pound object, objects arranged adjacent to each other in the game field 60 can be continuously selected, similarly to the dollar objects.

The determination module 46 is configured to determine whether a predetermined number or more of objects of the same type have been continuously selected from among the objects arranged in the game field 60. The “predetermined number” is 2 or more, and is smaller than an upper limit number of objects that can be arranged in the game field 60 (30 in the example of FIG. 3). For example, in the example of FIG. 3, the predetermined number is any integer between 2 and 29.

When it has been determined by the determination module 46 that the predetermined number or more of objects of one type have been continuously selected, the cancellation operation area generation module 47 generates a first cancellation operation area in a display area where an object of a different type from the objects of the one type is arranged, among the objects arranged in the game field 60.

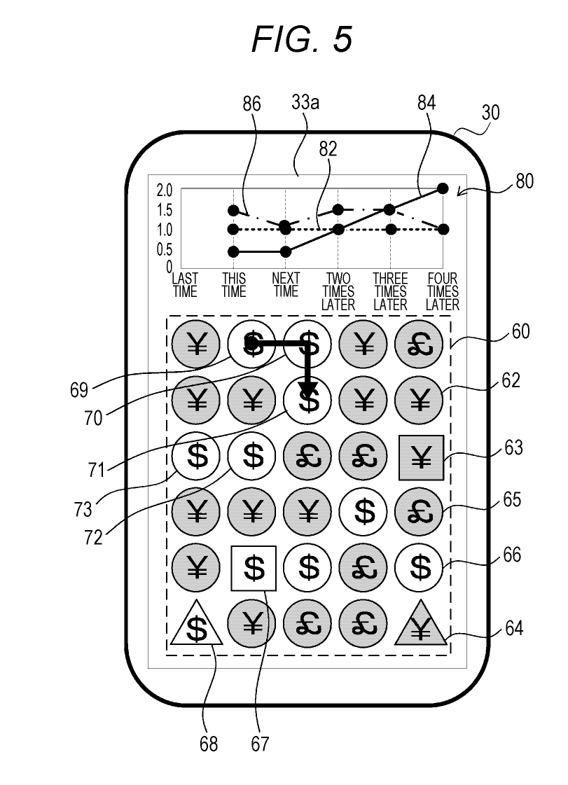

FIG. 5 illustrates a display example of the game screen including a transaction operation area. In the example of FIG. 5, when three of objects of the same type have been continuously selected by the player, the display areas of objects of different types from the objects of the selected type are caused to be the cancellation operation areas by the cancellation operation area generation module 47. To be specific, in the example of FIG. 3, the player has selected the dollar objects 69, 70, and 71 in that order. Therefore, it has been determined by the determination module 46 that a predetermined number of objects (here, “three”) have been continuously selected, and the display areas in which the yen object and the pound object that are different types from the dollar object are arranged are changed to the cancellation operation areas by the cancellation operation area generation module 47. In the example of FIG. 5, the shaded parts in the game field are the cancellation operation areas.

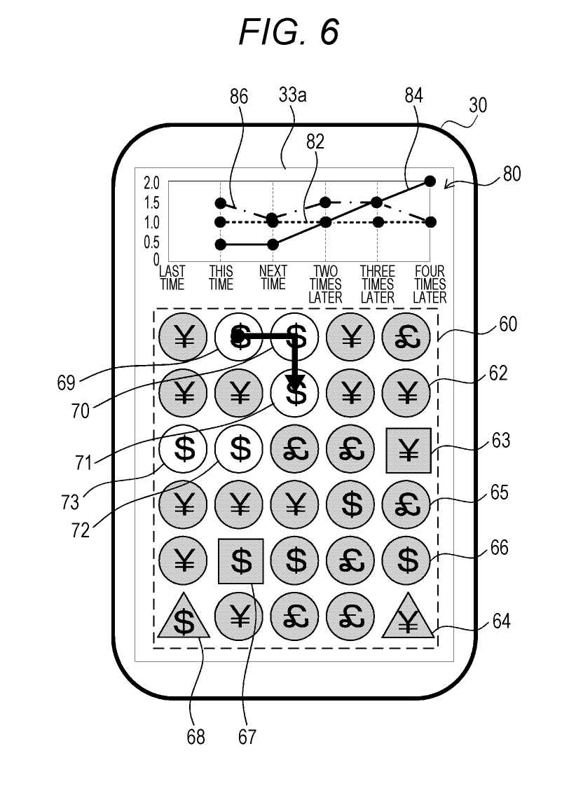

The display form of the cancellation operation area is not limited to the one illustrated in FIG. 5. FIG. 6 illustrates another display example of the cancellation operation area. As illustrated in FIG. 6, when a predetermined number or more of objects of the same type have been selected by the player, the cancellation operation area generation module 47 can cause display areas, in which objects that cannot be continuously selected based on the current selection operation are arranged, among the display areas in which the objects of the same type are arranged, to be the cancellation operation areas, in addition to the display areas of objects of other types. In the example of FIG. 6, the dollar objects 66, 67, 68, and the like are the same type as the objects selected at the moment (the dollar objects 69, 70, and 71), but cannot be selected from the dollar object 71, which is being selected at the moment, in the same turn. Therefore, the display areas in which these dollar objects are arranged are caused to the cancellation operation areas. Note that, in the embodiment of FIG. 6, the dollar object 73 is not adjacent to the dollar object 71, but can be selected following the dollar object 72, and thus is not the cancellation operation area.

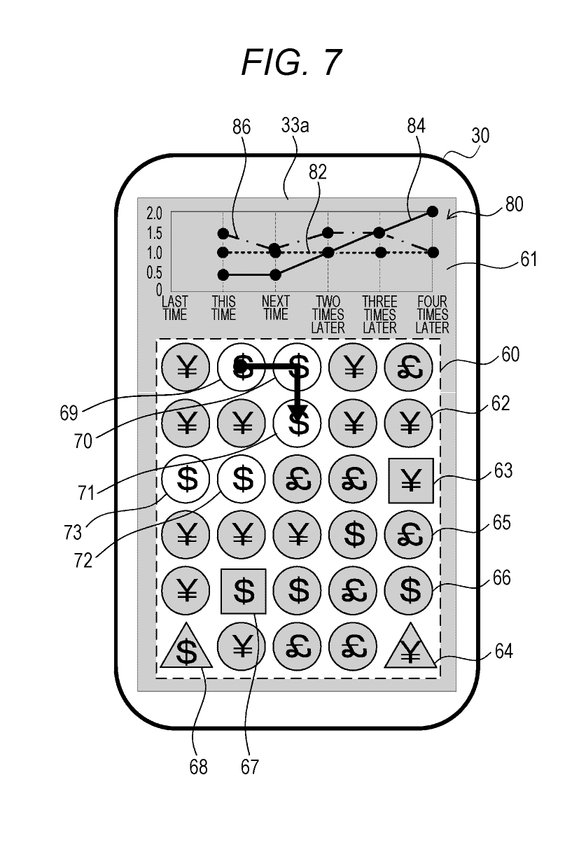

FIG. 7 illustrates another display example of the cancellation operation area. As illustrated in FIG. 7, the cancellation operation area generation module 47 can cause a part or all of the areas other than the object field 60 in the game screen to be the cancellation operation areas, in addition to the cancellation operation area illustrated in FIG. 6. In the present specification, the cancellation operation area in the object field 60 may be referred to as “first cancellation operation area”, and the cancellation operation area outside the object field 60 in the game screen may be referred to as “second cancellation operation area”. When it is not necessary to distinguish the both cancellation operation areas, they are simply referred to as “cancellation operation areas”. The embodiment of FIG. 7 illustrates an example in which all parts other than the object field 60 in the game screen are the second cancellation operation areas. Other than the example illustrated in FIG. 7, only right and left parts and a lower part of the game field 60 may be the cancellation operation areas, or only the exchange rate field 80 may be the second cancellation operation area.

As illustrated in any of FIGS. 5 to 7, the player can select the cancellation operation area when the cancellation operation area is generated. When the cancellation operation area is selected by the player, the selection cancellation module 48 cancels the selection operations so far, and returns the game screen to an initial state of the turn (the state of FIG. 3). The player can start the selection operation of the objects again from the initial state of the turn displayed in FIG. 3.

In the embodiment of FIG. 5, the player can select the cancellation operation area by, for example, sliding a finger from the position of the dollar object 71 to an area corresponding to the yen object arranged between the dollar object 69 and the dollar object 72. As described above, in the embodiment of FIG. 5, in the middle of selecting objects in a unicursal manner (before the confirmation of the selection operation), a display area adjacent to the display area of a most newly selected object becomes the cancellation operation area (in the embodiment of FIG. 5, the display areas in which the yen objects and the pound object are arranged among the display areas adjacent to the display area in which the dollar object 71 is displayed, when the dollar object 71 is selected). Therefore, the player can perform a cancellation operation by slightly sliding the finger placed on the display 33a for selecting an object. Accordingly, an operation error that selection of an object is wrongly confirmed with the intension of performing a cancellation operation can be prevented.

When a predetermined confirmation condition has been satisfied before the cancellation operation area is selected, the selection confirmation module 49 confirms the selection of objects of one type that have been selected by that time. The confirmation conditions include (1) releasing the finger that is in contact with the display 33a for a selection operation from the display 33a, (2) releasing the finger that is in contact with the display 33a for a selection operation from the display 33a and then tapping the display 33a, (3) not detecting the movement of the finger that is in contact with the display 33a for a selection operation for a certain period (for example, three seconds), and (4) no continuously selectable objects in the game field. However, the confirmation conditions applicable to the present invention are not limited to the above example. For example, confirmation of the selection operation can be input by pressing of an operation button other than the display 33a, or by means of a voice input for selection confirmation, or the like. Further, a combination of two or more conditions (1) to (4) can be the confirmation condition. Other than the above, any known method used for confirming an input in a game can be used unless the method is against the gist of the present invention.

For example, in the example illustrated in FIG. 5, the position of the display 33a, in which the dollar object 71 is displayed, is being selected by the player with the finger. Therefore, the player can confirm the selection of the dollar objects 69, 70, and 71 that have been selected by that time by releasing the finger from the display 33a (fulfillment of the confirmation condition (1)). Further, in the example of FIG. 4, when the dollar object 73 has been selected, there is no continuously selectable dollar object in the game field 60 (no dollar object adjacent to the dollar object 73 and which has not been selected yet). Therefore, when the dollar object 73 is selected, the selection of the dollar objects 69, 70, 71, 72, and 73 that have been selected by that time can be confirmed (fulfillment of the confirmation condition (4)). Further, in the example of FIG. 4, the selection of the objects that have been selected by that time can be confirmed by the elapse of a predetermined time after the selection of the dollar object 73 (fulfillment of the confirmation condition that is a combination of the confirmation conditions (3) and (4)).

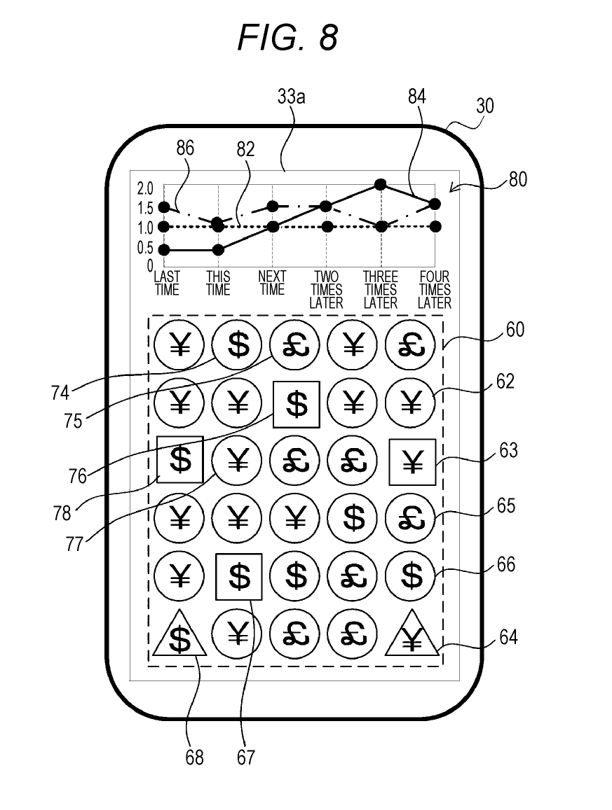

The object selected by the selection operation of the player is deleted from the object field 60 when the selection operation is confirmed. In the display area in which the deleted object was arranged, another object is arranged in the next turn according to a predetermined arrangement rule. FIG. 8 illustrates a display example of the game screen of the next turn when the five dollar objects of the dollar objects 69 to 73 have been selected in the turn illustrated in FIG. 4. In the object field 60 of FIG. 6, new objects 74 to 78 are respectively arranged in the display areas in which the dollar objects 69 to 73 were placed, in place of the dollar objects 69 to 73 selected in the previous turn. In the object field 60 in the turn of FIG. 6, objects other than the objects 74 to 78 are unchanged from the objects arranged in the previous turn.

In the embodiments of the present invention, various rules can be used as the arrangement rule of the new objects in place of the objects deleted by the selection of the player. For example, in one embodiment, when five or more of objects of the same type have been continuously selected, two objects of the same type as the selected objects but in a higher rank, and three objects in the lowest rank (which may be the same type as the selected objects or a different type from the selected objects) are displayed in the game field 60 in place of the deleted objects as the new objects in place of the selected five objects. In the example of FIG. 4, five dollar objects in the lowest rank have been continuously selected. Therefore, in the next turn, the dollar objects 76 and 78 in the medium rank that is one rank higher than the lowest rank are arranged in two display areas among the display areas in which the selected dollar objects 69 to 73 were arranged, and the dollar object 74, the pound object 75, and the yen object 77 in the lowest rank are arranged in the rest of the display areas, as illustrated in FIG. 8. The rule for arranging new objects applicable to the present invention is not limited to the above example, and various arrangement rules can be employed in order to enhance strategic characteristics of the game in the present invention.

When the selection of the objects has been confirmed by the selection confirmation module 49, the acquisition point determination module 50 calculates the acquisition point to be acquired by the player according to a predetermined calculation logic. In an embodiment of the present invention, the acquisition point is calculated based on the points associated with the objects selected by the player (the reference point or the variation point) and the number of the selected objects. For example, as illustrated in FIG. 5, when five yen objects that are the reference objects in the lowest rank have been selected, the acquisition point is calculated based on the reference point (100 points) and the number of the selected objects (here, “5”). In the embodiment of FIG. 5, the five yen objects (reference objects) have been continuously selected. Therefore, 500 points that is obtained by multiplying the reference point “100 points” by the number of the continuously selected objects “5” are the acquisition point to be acquired by the player. The calculation logic of the acquisition point applicable to the present invention is not limited to the above-described example, and various calculation logics can be applied to the present invention. For example, the acquisition point of when the reference objects are selected may be determined to be exponentially increased as the number of continuously selected reference objects is increased. In contrast, the acquisition point may not be increased even if the number of the continuously selected reference objects is increased, and the reference point may be acquired at all times.

An example of the method of calculating the acquisition point of when the variation object is selected will be described. As illustrated in FIG. 4, when a dollar object that is the variation object is selected, the acquisition point of the player is calculated based on the variation point associated with the dollar object. The variation point associated with the dollar object is, as described above, calculated by multiplying the reference point by the yen-dollar exchange rate, for example. As illustrated in the exchange rate field 80 of FIG. 4, the yen-dollar exchange rate in the turn illustrated in FIG. 4 is “0.5”. Therefore, the variation point associated with the dollar object is 50 points. The acquisition point determination module 50 calculates the acquisition point to be acquired by the player based on the variation point. For example, in the example of FIG. 4, the five dollar objects have been selected. Therefore, 250 points that are obtained by multiplying the variation point “50 points” associated with the dollar object by the number of the continuously selected objects “5” are the acquisition point to be acquired by the player. The calculation logic of the acquisition point based on the variation point applicable to the present invention is not limited to the above-described example, and various calculation logics can be applied to the present invention.

In an embodiment of the present invention, the objects can be continuously selected as long as they are objects of the same type, even if they are classified into different ranks. That is, the player operation detection module 45 can detect the selection operation of the objects classified into different ranks but of the same type as an effective selection operation. For example, in the turn illustrated in FIG. 4, the yen object 63 in the medium rank and the yen object 62 in the lowest rank arranged adjacent above can be continuously selected. In this way, when the objects in the different ranks are selected, the acquisition point is calculated based on the reference point or the variation point in each rank. For example, in the example illustrated in FIG. 4, when the yen object 62 and the yen object 63 have been selected, the acquisition point is calculated based on the reference point in the lowest rank associated with the yen object 62 (for example, 100 points) and the reference point in the medium rank associated with the yen object 63 (for example, 1000 points). To be specific, 1100 points that are obtained by adding the reference point “100 points” in the lowest rank and the reference point “1000 points” in the medium rank are calculated as the acquisition point, for example. Further, when objects in different ranks have been selected, the acquisition point can be calculated in consideration of the number of the selected objects in each rank, in addition to the reference point or the variation point of each rank. For example, when one reference object in the lowest rank and two reference objects in the medium rank have been selected, “2100 points”, which is obtained by adding “2000 points”, which are obtained by multiplying the reference point “1000 points” in the medium rank by the number of the selected reference objects in the medium rank “2”, to the reference point “100 points” in the lowest rank, are calculated as the acquisition point.

The acquisition point determination module 50 can calculate a total of the acquisition point acquired in each of the turns that have passed from the start of the game, in addition to the above-described calculation of the acquisition point in each turn. The total of the acquisition points from the start of the game combined in this way may be displayed in the display 33a as a part of the game screen.

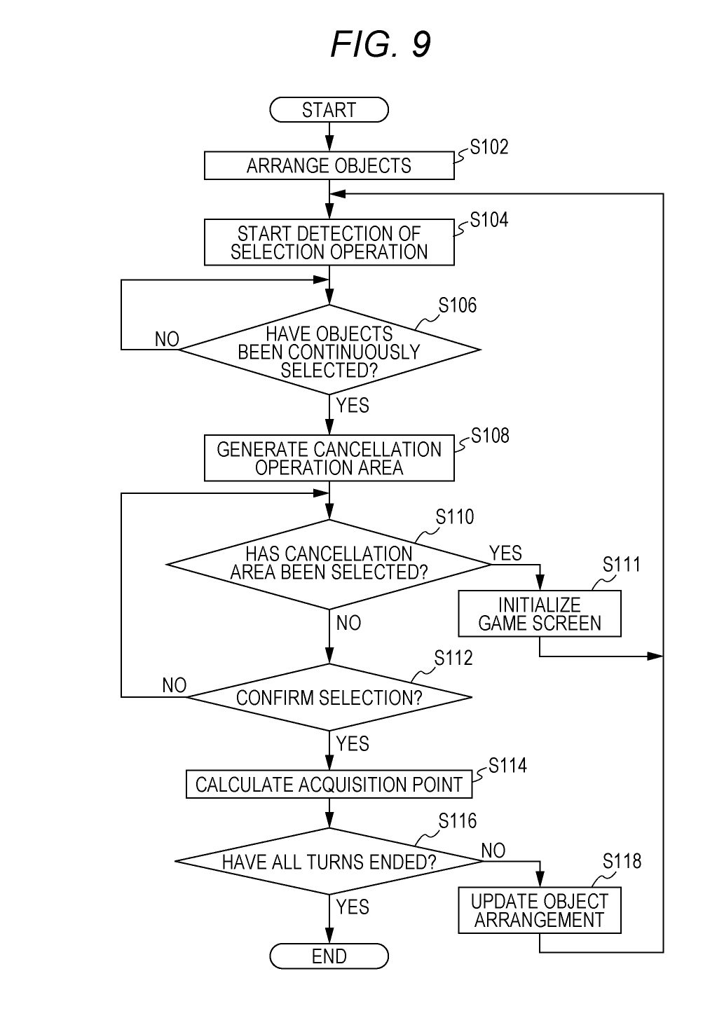

Next, a flow of processing in an embodiment of the present invention will be described with reference to FIG. 9. FIG. 9 is a flowchart illustrating an example of a flow of processing from the start to the end of the above-described puzzle game due to the elapse of predetermined turns according to an embodiment of the present invention.

When the puzzle game is started, first, in step S102, the objects are respectively arranged in the display areas in the object field 60, as illustrated in FIG. 3, and the game screen including the object field 60 in which the objects are arranged is presented to the player. The processing in step S102 are mainly executed by the game field display module 42 and the object arrangement module 43, for example. The exchange rates between the reference point associated with the reference object (yen object) and the variation points associated with the variation objects (the dollar object and the pound object) are displayed in the exchange rate field 80 in the game screen. In an embodiment, the exchange rates of five turns including the first turn at the start of the game are displayed in the exchange rate field 80.

When the processing of step S102 has been completed, the game screen as illustrated in FIG. 3 is displayed in the display 33a of the terminal device 30. Thirty objects are displayed in the object field 60 of the game screen, and the yen-dollar exchange rate and the yen-pound exchange rate in each of the current turn and four turns ahead are displayed in the exchange rate field 80. The player who is in contact with the game screen can refer to the arrangement of the objects in the object field 60 and the current and future exchange rates displayed in the exchange rate field 80 and discuss the strategy to maximize the acquisition point till the end of the game.

Next, in step S104, detection of a selection operation of the player to the objects arranged in the object field 60 is started. The detection of a selection operation to the objects arranged in the object field 60 is continuously performed until the cancellation area is selected or the selection is confirmed in the steps described below. The player can select a desired object by an operation of tapping or dragging from among the objects displayed in the game field 60. The object selected by the player is mainly detected by the player operation detection module 45.

Next, proceeding to step S106, whether a predetermined number or more of objects of one type have been continuously selected is determined. This determination is mainly performed by the determination module 46.

When it has been determined that a predetermined number or more of objects of one type have been continuously selected, the processing proceeds to step S108, and the cancellation operation areas are provided in the game screen. Regarding the cancellation operation area, the display areas in which objects of different types (for example, the yen object and the pound object) from the objects of the one type (for example, the dollar objects) that have been continuously selected are arranged are set as first cancellation operation areas, as illustrated in FIG. 5. Generation of the cancellation operation areas is mainly performed by the cancellation operation area generation module 47.

When the processing of step S108 is completed, the first cancellation operation areas are displayed on the game screen identifiable to the player, as illustrated in FIG. 5. The display of the first cancellation operation areas is realized by, for example, gray-out of the objects of the different types from the continuously selected objects. In step S110, whether the first cancellation operation area has been selected by the player is determined, and the processing is transferred to step S111 when the first cancellation operation area has been selected. As illustrated in FIG. 7, when a second cancellation operation area is generated outside the field 60, whether either the first or the second cancellation operation area has been selected is determined in step S110, and when one of the cancellation operation areas is selected, the processing is transferred to step S111.

In step S111, the game screen is initialized. The initialized game screen is the same as one displayed at the completion of step S102 in terms of the arrangement of the objects and the display of the exchange rates. When the initialized game screen is displayed, the processing proceeds to step S104 again, and detection of a selection operation of the player on the initialized game screen is started.

Meanwhile, when both of the first and the second cancellation operation areas have not been selected, the processing proceeds to step S112, and whether the confirmation condition of the selection operation has been satisfied is determined. When the confirmation condition of the selection operation has been satisfied, the processing proceeds to S114. When the confirmation condition has not been satisfied, detection of the selection operation of the objects by the player is continued, and the processing returns to step S110 and whether the first or the second cancellation area has been selected is determined. The determination of whether the confirmation condition of the selection operation has been satisfied is mainly performed by the selection confirmation module 49. The detection of the selection operation of the objects, the determination of whether there is selection of the first or the second cancellation area, and the determination of whether the confirmation condition has been satisfied are continued until it is determined that the confirmation condition has been satisfied in step S112.

In step S112, when the confirmation condition of the selection operation has been satisfied, the processing proceeds to step S114, and the acquisition point in the current turn is calculated. The acquisition point in the current turn is calculated based on the reference point, the rank, and/or the exchange rate, as described above. Further, the acquisition point in the current turn is combined with the acquisition point in the previous turns, that is, the current acquisition point is combined with the acquisition point up to the turn, and a total acquisition point of the passed turns is calculated.

As described above, when the selection of the objects by the player and the calculation of the acquisition point have been completed in the current turn, the processing proceeds to step S116, and whether all of predetermined turns have ended is determined. When all of the turns have not ended, the processing proceeds to step S118, and the objects arranged on the object field 60 are updated as illustrated in FIG. 8, for example. This update of the objects is mainly executed by the object arrangement module 43. Next, the processing proceeds to step S114, and the exchange rates displayed in the exchange rate field 80 are updated as illustrated in FIG. 8, for example.

As described above, when the objects and the exchange rates have been updated, the game screen including the object field 60 including the updated objects and the exchange rate field 80 including the updated exchange rates is displayed in the display 33a. Then, the processing proceeds to step S104 again, and a selection operation of the player to the game screen including the updated objects and exchange rates is received.

The processing of steps S104 to S118 is repeatedly performed until it is determined that all of the turns have ended in step S116. When it has been determined that all of the turns have ended in step S116, the puzzle game in the present embodiment ends.

In the present specification, an embodiment of the present invention has been described using a case in which the modules of FIG. 2 are executed in the terminal device 30, as an example. However, as described above, the modules of FIG. 2 may be executed by a processor provided outside the terminal device 30 (for example, the processor 11 of the server 10) or a processor provided in another terminal device. Therefore, an aggregation of information processing devices provided with a processor that executes at least a part of the modules illustrated in FIG. 2 configure the game providing system of the present invention. For example, when the functions of the modules of FIG. 2 are processed by the terminal device 30 and the server 10 in a distributed manner, the system configured from the terminal device 30 and the server 10 can be considered as an embodiment of the game providing system of the present invention.

Even if the processing and the procedures described in the present specification have been described to be executed by a single device, a piece of software, a single component, or a single module, such processing and procedures can be executed by a plurality of devices, a plurality of pieces of software, a plurality of components, and/or a plurality of modules. Further, even if the data, the table, and the database described in the present specification have been described to be stored in a single memory, such data, a table, and a database can be stored in a plurality of memories provided in a single device, or a plurality of memories distributed in a plurality of devices, in a distributed manner. Further, the elements of the software and the hardware described in the present specification can be realized by being integrated into a fewer configuration elements or by being disintegrated into more configuration elements.

In the present specification, even if the configuration element of the invention has been described in either a singular or plural form, or even if the configuration element has been described without limiting the singular or plural form, the configuration element may be a single element or a plurality of elements except that they should be understood separately in its context.

In the processing procedure described in the present specification, especially, in the processing procedure described with reference to the flowchart, it is possible to omit a part of the steps that constitute the processing procedure, to add a step not explicitly indicated as a step that constitutes the processing procedure, and/or to replace the order of the steps, and a processing procedure to which such omission, addition, and change of the order has been made is included in the scope of the present invention as long as it does not depart from the gist of the present invention.

What is claimed is:

1. A game providing system comprising:
an object arrangement unit configured to arrange one object from among a plurality of types of objects to each of a plurality of display areas included in a game field;
a determination unit configured to determine whether a predetermined number or more of objects of one type have been continuously selected from among a plurality of objects arranged in the plurality of display areas by a selection operation of a player;
a cancellation operation area generation unit configured to cause a display area in which an object of a different type from the objects of one type is arranged among the objects arranged in the plurality of display areas to be a first cancellation operation area when it has been determined by the determination unit that a predetermined number or more of objects of one type have been continuously selected;
a selection cancellation unit configured to cancel the selection of the objects of one type when the first cancellation operation area has been selected;
a selection confirmation unit configured to confirm the selection of the objects of one type when a predetermined confirmation condition has been satisfied before the first cancellation operation area is selected; and
an acquisition point determination unit configured to determine an acquisition point to be acquired by the player when the selection of the objects of one type has been confirmed by the selection confirmation unit.

2. The game providing system according to claim 1, wherein a second cancellation operation area is included outside the game field in a game screen, and
the selection cancellation unit cancels the selection of the objects of one type when either the first cancellation operation area or the second cancellation operation area has been selected.

3. The game providing system according to claim 1, wherein the acquisition point determination unit determines the acquisition point based on points associated with the objects of one type.

4. A non-transitory computer-readable storage medium storing a game program for causing a computer to function as:
an object arrangement unit configured to arrange one object from among a plurality of types of objects to each of a plurality of display areas included in a game field;
a determination unit configured to determine whether a predetermined number or more of objects of one type have been continuously selected from among a plurality of objects arranged in the plurality of display areas by a selection operation of a player;
a cancellation operation area generation unit configured to cause a display area in which an object of a different type from the objects of one type is arranged among the objects arranged in the plurality of display areas to be a first cancellation operation area when it has been determined by the determination unit that a predetermined number or more of objects of one type have been continuously selected;
a selection cancellation unit configured to cancel the selection of the objects of one type when the first cancellation operation area has been selected;
a selection confirmation unit configured to confirm the selection of the objects of one type when a predetermined confirmation condition has been satisfied before the first cancellation operation area is selected; and
an acquisition point determination unit configured to determine an acquisition point to be acquired by the player when the selection of the objects of one type has been confirmed by the selection confirmation unit.

5. A method of providing a game executed by a computer, the method comprising:
an object arrangement step of arranging one object from among a plurality of types of objects to each of a plurality of display areas included in a game field;
a determination step of determining whether a predetermined number or more of objects of one type have been continuously selected from among a plurality of objects arranged in the plurality of display areas by a selection operation of a player;
a cancellation operation area generation step of causing a display area in which an object of a different type from the objects of one type is arranged among the objects arranged in the plurality of display areas to be a first cancellation operation area when it has been determined in the determination step that a predetermined number or more of objects of one type have been continuously selected;
a selection cancellation step of cancelling the selection of the objects of one type when the first cancellation operation area has been selected;
a selection confirmation step of confirming the selection of the objects of one type when a predetermined confirmation condition has been satisfied before the first cancellation operation area is selected; and
an acquisition point determination step of determining an acquisition point to be acquired by the player when the selection of the objects of one type has been confirmed in the selection confirmation unit.
